(19) United States
(12) Patent Application Publication
(10) Pub. No.: US 2009/0295949 A1
(43) Pub. Date: Dec. 3, 2009

(54) ZOOM CAMERA ARRANGEMENT COMPRISING MULTIPLE SUB-CAMERAS

(75) Inventor: Kai Markus OJALA, OULU (FI)

Correspondence Address: YOUNG & THOMPSON, 209 Madison Street, Suite 500, ALEXANDRIA, VA, 22314, US

(73) Assignee: VALTION TEKNILLINEN TUTKIMUSKESKUS, ESPOO (FI)

(21) Appl. No.: 12/473,512

(22) Filed: May 28, 2009

(30) Foreign Application Priority Data
May 28, 2008 (FI) 20085510

(51) Int. Cl. H04N 5/262

(52) U.S. Cl. 348/240.99; 348/E09.011

(57) ABSTRACT

A zoom camera arrangement includes two or more sub-camera entities for funneling incoming light towards one or more associated digital image sensor chips for converting light into electric signal, each chip including a sensor area for capturing light funneled by at least one associated sub-camera entity of the two or more sub-camera entities, wherein each of the sub-camera entities includes a lens assembly incorporating a number of lenses disposed as one or more lens layers of the lens assembly, the number of lenses of the lens assembly being fixedly positioned relative to the at least one associated digital image sensor chip of the one or more digital image sensor chips, wherein the lens assemblies of the two or more sub-camera entities are selected so as to provide two or more different zoom steps, for enabling the imaging apparatus to provide optical zoom functionality via the selection of the sub-camera entity.

### FIELD OF THE INVENTION

Generally the invention relates to optics and electronics. Particularly, however not exclusively, the invention pertains to an arrangement for an imaging apparatus such as a digital camera, wherein the arrangement comprises multiple sub-cameras to provide multiple zoom steps.

### BACKGROUND

Digital imaging, e.g. acquisition of digital still or video image data representing a target view or target entity via a camera apparatus, is nowadays one of the key drivers of the consumer electronics industry. Digital cameras and other devices incorporating them, such as mobile terminals, personal digital assistants (PDAs), and computers in general, have become standard gear of not just imaging professionals but also ordinary consumers in the world of global communication and multimedia almost irrespective of their profession, social status, sex, age, etc.

In contrast to professional equipment, however, the importance of manufacturing costs and resulting product price has grown considerably in making component selection and production decisions covering mass market consumer electronics apparatuses comprising camera functionality. Accordingly, as the camera feature does not typically constitute the whole motivation, and in many cases not even major motivation when considering e.g. PDAs or mobile terminals, for obtaining and using the associated electronic host device, the camera-related additional manufacturing costs shall be kept minimum while still providing tolerable image quality in terms of maximally low aberrations etc. and decent usability experience to the user of the device whenever a more or less occasional need for the camera application occurs.

Zoom functionality is rather common feature in all but the most affordable cameras such as disposable ones. Zoom may be provided via optical and/or digital implementations. Digital zooming may performed by software through picking out a desired portion from a target image, which has been obtained by a camera module, and interpolating new pixel values to reside between the originally captured ones such that the resulting image size is extended back to the size of the target image or some other predetermined size, for example. Digital zooming is thus mere mathematical data manipulation and guesstimation, whereupon the resulting image is inferior also in perceived quality especially when larger zoom levels are applied. Optical implementations apply optical principles to obtain the same effect of altering the angle of view of the digital sensor or of other image capturing element. In optical zoom the focal length of the imaging lens arrangement of the camera apparatus is changed by adjusting the selected individual lens or lens group positions within the arrangement relative to the image sensor, for example. As the lenses and/or other elements are mechanically moved along the optical axis by electrically controlled motors that shall be thus provided with the camera arrangement together with e.g. position sensor(s), both the size and price of the camera arrangement goes up and manufacturing thereof gets more complicated all along.

FIG. 1 illustrates an exemplary sketch of one possible optical zoom lens arrangement 102 comprising several lenses 104a, 104b, 104c, and 106 for directing light towards a destination element such as an image sensor 108 on a circuit board 110 located on a focal plane of the arrangement 102. The first three lenses 104a, 104b, and 104c form an afocal zoom system 104 that alters (widens/narrows) the incoupled beam by finely controlled and interdependent compensatory movement of positive lens 104a and negative lens 104b, notice the bidirectional arrows in the figure depicting this, such that the outcoupled beam therefrom 104 is not focused or split but merely widened/narrowed (in the illustrated example slightly widened) instead so as to maintain the focal plane position intact. It is rather obvious that in order to move lenses a precise control means such as servo-controlled motors are required, which makes the arrangement 102 more complex, fragile, expensive and space-consuming.

Surface-mount devices such as various chips may be mounted to a substrate such as a PCB (printed circuit board) by depositing solder paste to predetermined locations on the substrate and placing the devices on these locations so that during higher temperature reflow procedure the solder paste melts and creates the desired bonding between the devices and the substrate. Temperature rise/decrease phases may precisely controlled via several steps (preheating, reflow, cooling, etc.) to achieve predetermined properties for the solder bonding and to reduce risks introduced to the substrate and other components caused by the thermals stress during the reflow procedure. Reflow is typically carried out with a reflow oven that subjects the substrate and devices thereon to the utilized reflow effect, e.g. Infrared or Convection heating. Material reflow via heating may also be applied in manufacturing lenses or other objects. For example, a resist or other material may be placed on a substrate and heated for fluidization. Then the material may deform, e.g. due to a used mold or the effect of surface tension, into a lens shape, or lenslet array comprising multiple lens forms. In some methods the process continues such that the substrate/resist aggregate is subjected to anisotropic dry etching so that the lens shape is transferred onto the substrate itself, which is then to be used as the lens. Alternatively, a desired lens, such as an epoxy or e.g. PMMA (polymethyl methacrylate) or other polymeric lens, or a lenslet array comprising several lenses, may be formed on a substrate by transferring the lens shape from a master tool into curable material, for instance.

However, as in many production-wise preferable, both efficient and affordable, known manufacturing methods the lens arrangement and/or other related, possibly complex elements would be exposed to undue heat and thermal stress, which e.g. in conjunction with multi-part motored optical zoom system with various movable parts being sensitive to heat, might ultimately hinder the use of such methods completely, the lens arrangement and other related elements should be then separately provided in dedicated manufacturing steps, which is in many ways less preferable solution. In addition, contemporary zoom arrangements require considerable amount of room for the various necessary elements, which impedes manufacturing really compact-sized and light electrical gadgets with optical zoom camera functionality.

### SUMMARY OF THE INVENTION

The objective of the embodiments of the present invention is to at least alleviate one or more of the aforesaid drawbacks evident in the prior art arrangements in the context of zoom capable cameras and related devices. The objective is achieved with a zoom camera arrangement comprising multiple sub-camera entities.

Namely, in accordance with one aspect of the present invention a zoom camera arrangement for an imaging apparatus comprises
two or more sub-camera entities for funneling incoming light towards one or more associated digital image sensor chips,
one or more digital image sensor chips for converting light into electric signal, each chip comprising a sensor area for capturing light funneled by at least one associated sub-camera entity of said two or more sub-camera entities,
   wherein each of said sub-camera entities comprises a lens assembly incorporating a number of lenses disposed as one or more lens layers of the lens assembly, said number of lenses of said lens assembly being fixedly positioned relative to the associated digital image sensor chip of said one or more digital image sensor chips, wherein the lens assemblies of said two or more sub-camera entities are selected so as to provide two or more different zoom steps, respectively, for enabling the imaging apparatus to provide a particular zoom step of a multi-level optical zoom functionality via the selection of the corresponding sub-camera entity.

The above zoom camera arrangement, wherein certain optical zoom step (angle of view), or “zoom level”, is advantageously provided via the selection of the associated sub-camera entity, is, depending on the utilized materials, preferably suitable for reflow manufacturing of an imaging apparatus and it may be implemented as one or more camera modules that may be advantageously coupled via a reflow soldering method to a substrate such as a printed circuit board like many other components. The used materials shall be preferably selected so as to maintain their preferred properties such as form during the application of the selected reflow method. For example, they should still withstand the heat produced by the reflow, even if the material itself is not to be fluidized during it. Further, the dimensions and structure of the arrangement are such that they enable handling it analogously with other components as more complex adjustment and support structures are not required. In addition to reflow soldering, or as an alternative, also one or more lenses may be manufactured utilizing a method applying the reflow properties of the associated material. Embodiments of the present invention may utilize reflowable (soldering of the camera module and/or forming one or more lenses)) configuration of wide angle and tele imaging lens types in the same camera apparatus. For example, same lens positions may be utilized in each sub-camera for facilitating (reflow) mass fabrication, for instance.

The above zoom camera arrangement may be utilized to implement a camera capable of optical zoom without moving components, i.e. the necessary lens components are preferably substantially fixed. The selection of the contemporary zoom step may be initiated via software such that image data from the associated sub-camera and sensor is retrieved and, for example, visualized on the display of the imaging apparatus in response to user input obtained from the user of the apparatus via the available UI. During utilization of a certain optical zoom step and related sub-camera, sensor(s) associated with other sub-cameras may optionally be turned off for power-saving purposes.

Each lens assembly may comprise one or more lenses, e.g. a reversed telephoto lens assembly (or at least reversed telephoto group) or telephoto lens assembly (/group), for wide angle or tele imaging, respectively.

The sub-camera entities and lens assemblies thereof are preferably adjacent or otherwise closely located such that the difference in the optical axis/angle of sight between them is kept minimal and/or the number or size of the required sensors or sensor area(s), respectively, may be minimized. Multiple lenses of adjacent sub-cameras may be implemented as a lenslet structure.

The digital image sensor chip may include e.g. a CMOS (complementary metal oxide semiconductor) or CCD (charge coupled device) sensor.

As alluded hereinbefore, the camera arrangement may be included in or at least functionally coupled to an imaging apparatus such as a dedicated digital still or video camera apparatus, a mobile terminal, a PDA, a laptop/desktop computer device, a digital music player, etc.

The apparatus incorporating the camera arrangement may include a processing means for providing additional digital zoom capability and/or handling the zoom step selection requests from the user thereof. The digital zoom may be provided to provide zoom steps between or outside the available optical ones, for instance.

In accordance with another aspect, one or more digital image sensors and multiple, adjacent sub-camera entities with substantially parallel optical axes, each entity comprising a fixed lens assembly with a characterizing optical zoom step and forming an image of incoupled light to a predetermined light-sensitive area of a predetermined digital image sensor of said one or more sensors, are used to form a multi-step optical zoom camera arrangement wherein a particular optical zoom step is switchable via the selection of the associated sub-camera entity.

The utility of the present invention arises from a plurality of issues depending on each particular embodiment. As the arrangement may be manufactured as reflow compatible, the overall manufacturing costs may be kept low and number of manufacturing steps minimized. The camera module comprising e.g. sensor chip(s) and at least part of related optics advantageously withstands the reflow soldering heat and may be thus mounted without complex special procedures or numerous additional process steps, for example. As moving parts are not necessary, the camera arrangement is robust. The size of the sub-camera optics and other elements may be optimized for providing minimum size, and the size of the arrangement is reduced also due to the fact that additional sensors/motors/servo-control are not required. For example, the size of fixed focus wide angle and telephoto lenses is smaller than the size of a corresponding variable focal length zoom lens. Also the lens(es) of a sub-camera may be better optimized for each particular zoom step than being possible with a single variable focal length zoom lens implementation.

The expression “a number of” may, in the context of the present application, refer to any positive integer starting from one (1). The expression “a plurality of” may refer to any positive integer starting from two (2), respectively.

Various embodiments of the present invention are disclosed in the attached dependent claims.

### BRIEF DESCRIPTION OF THE RELATED DRAWINGS

FIG. 1 illustrates one example of a prior art optical zoom lens assembly.

FIG. 2a illustrates an embodiment of the present invention including four sub-camera entities in the camera arrangement, each sub-camera incorporating two layers of lenses.

FIG. 2b illustrates one embodiment of the configuration and positioning of the sub-cameras in the camera arrangement of the present invention.

FIG. 3 illustrates one embodiment of a mixed optical and digital zoom in the context of the present invention.

FIG. 4 illustrates a further embodiment of the present invention with three lens layers per sub-camera.

FIG. 5 illustrates a further embodiment of the present invention with four lens layers per sub-camera.

FIG. 6 is a block diagram of one embodiment of an imaging apparatus including or at least connecting to the camera arrangement of the present invention.

### DETAILED DESCRIPTION OF THE EMBODIMENTS

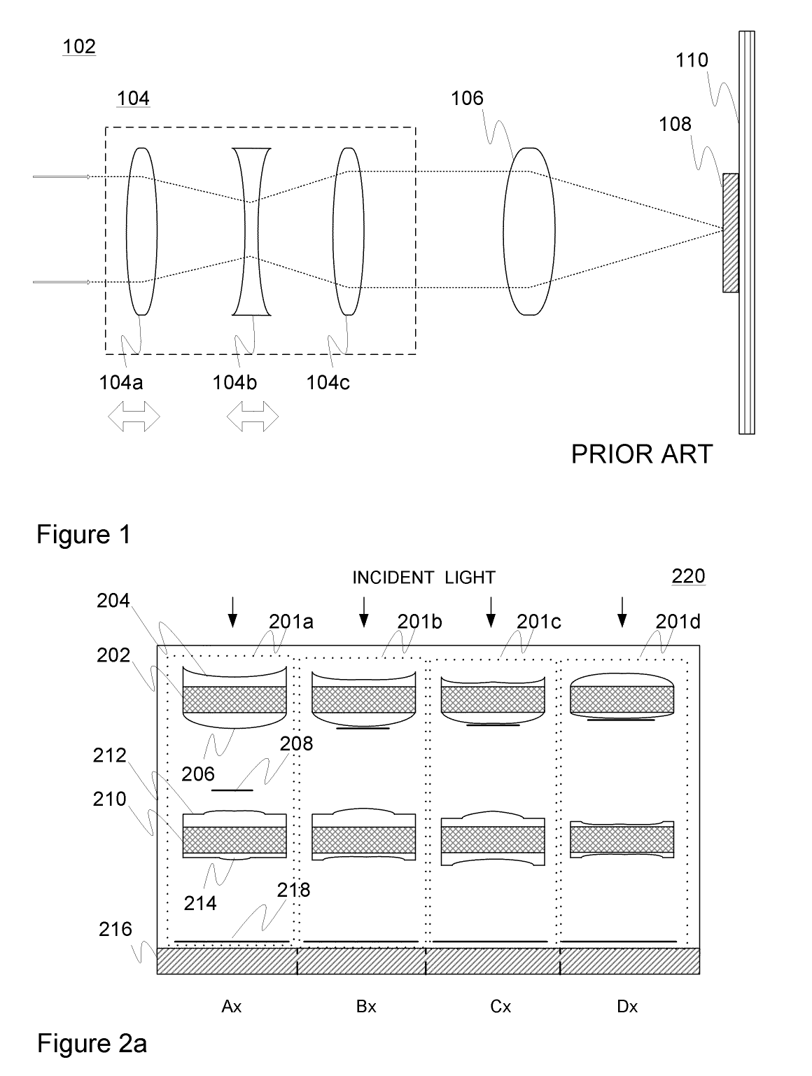

FIG. 1 was already contemplated hereinbefore in connection with the review of the background of the invention.

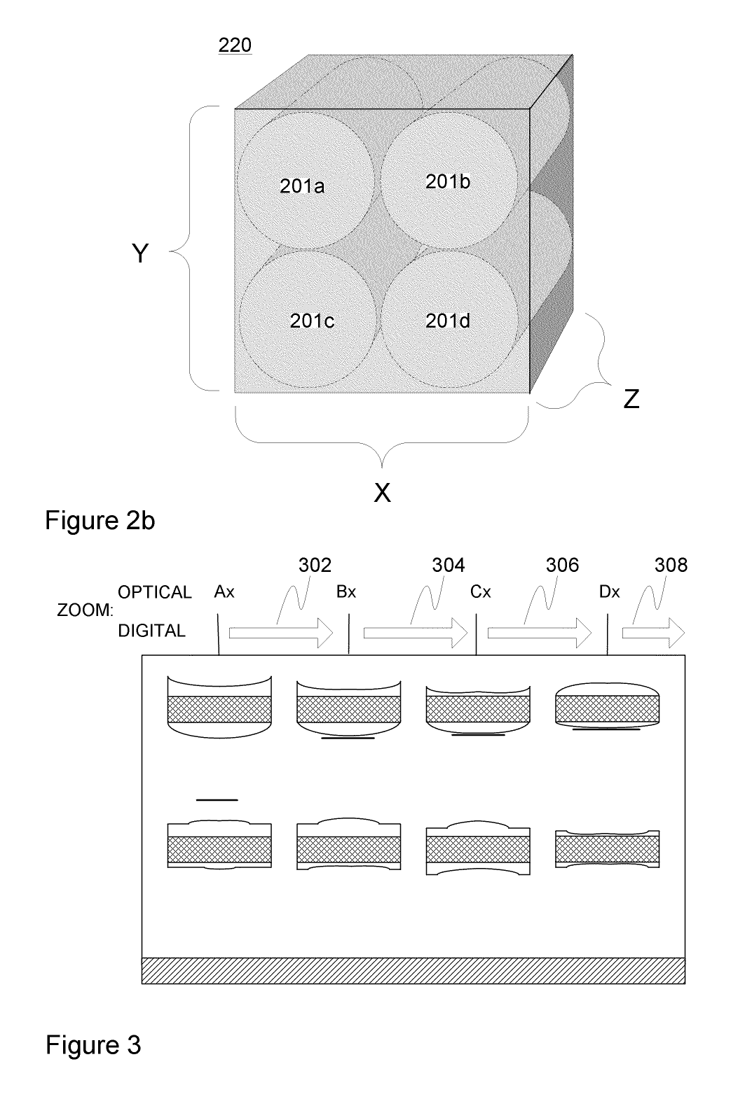

FIG. 2a illustrates one embodiment 220 of camera arrangement in accordance with the present invention. It shall be first noted that the illustrated elements are not necessarily drawn in scale, unless remarks to assume the contrary are explicitly given. In this particular example the arrangement comprises four sub-camera entities 201a, 201b, 201c, and 201d in order to provide four different zoom steps, or “factors”, Ax, Bx, Cx, and Dx, respectively, but in other embodiments other number, e.g. 2, 3, 5, or more, sub-camera entities may be applied. The sub-camera entities can be functionally considered as “lens tubes” or “barrels” that may be deposited adjacent to each other e.g. in matrix or row form. Advantageously, the placement of sub-cameras may be optimized co-operatively with the sensor area(s) such that the size of surplus, i.e. unused, sensor area(s) is minimized. The zoom steps may be set such that A equals to about 1(i.e. normal magnification), B equals to about 1.6, C equals to about 2.3, and D equals to about 3, for example, whereby the corresponding field angles may be about 60, 36, 25, and 10 degrees, respectively. In one embodiment, the height of the sub-camera element may be about 4 mm and diameter of lenses e.g. about 2 mm, for example.

Each sub-camera comprises a lens assembly including a number of lenses deposited on one or more layers. In the illustrated embodiment, one sub-camera only comprises one lens in lateral direction per each layer, but in other embodiments a lens layer of a sub-camera may also comprise several laterally neighbouring lenses in addition to merely superposed (either directly or with additional substrate or other spacer material between) lenses that typically share the same optical axis. In the exemplary sub-cameras 201a, 201b, 201c, 201d two lens layers are presented, the one with substrate portion 202 and the other with substrate portion 210. Each layer has two lenses 204, 206 and 212, 214, one formed on each side of the corresponding substrate. The lenses may be of the material of the substrate, or of different material deposited thereon. Lens locations relative to optical axis (vertical in the figure) and/or the number of lenses per sub-camera may be kept similar, i.e. substantially the same, in each sub-camera to ease the reflow manufacturing, for example. The lens design and e.g. aperture 208 size and/or aperture position may still differ between the sub-cameras. Naturally the lenses within a sub-camera may differ as well.

Reference numeral 216 denotes a sensor layer including a number of sensors and associated sensor areas whereto the lenses funnel, i.e. direct, the incoupled light. As the sub-camera entities 201a-d act as image-forming parts, the one or more sensors 216 could be likewise called as image-capturing part(s). The sensor area is typically divided into smaller picture elements, or “pixels”, that may be mutually similar. The pixels are often relatively small and typically range from few microns to over 100 microns in across corner dimension. Pixel size may be e.g. about 2.2×2.2 Mm. The sensors may be of CMOS or CCD technology, for example. A typical sensor implementation includes a chip accommodating a plurality of photodiodes for capturing light arriving at a predetermined sensor area thereof. The illustrated vertical broken lines depict the possibility to utilize a plurality of sensors, e.g. one for each one or two sub-cameras, instead of just one bigger sensor. The sensor may be a custom-made sensor or a more generic sensor, and it may further incorporate structures 218 such as shields, masks, apertures, etc. that direct/limit the incoupled light from reaching predetermined sensor area(s) or e.g. neighbouring sensors. Alternatively, such structures may be formed in the material residing at close proximity to the sensor in the light path, e.g. in the housing or medium of the corresponding sub-camera. The sub-cameras may also include stray-light baffling structures. One sensor may be configured to capture light from multiple, two or more, sub-camera entities by dividing the overall sensor area between several sub-cameras. The resolution of the sensor may be of any preferred order. It may substantially be of about VGA level (about 640×400 pixels), or megapixel class sensors may be utilized.

Illustration of FIG. 2a is mainly functional in a sense that the attachment and/or alignment of lenses relative to the sensor or the surrounding medium, e.g. a support structure of each sub-camera, is not explicitly shown and may be in practice implemented via a preferred technique depending on each particular use scenario.

The lenses of the lens assemblies may also be formed using different kind of methods. The lenses may be formed independently or as layers having a common substrate, for example. In one embodiment, at least part of the lenses may be formed as a number of lenslet arrays. Several lenslet arrays may be arranged in adjacent and/or successive layers. In some embodiments, even monolithic fabrication of lenses close to the sensor as integrated with the associated optoelectronics may be contemplated. Otherwise, a lens or a lens structure may be held in place by e.g. adhesive and/or a frame/molding structure.

The spacer medium between the lens layers, apertures, and/or the sensor area may be air or other non-solid material in the case of other existing support structures at the outer perimeter of the sub-camera to maintain the lenses static within the sub-camera. In another embodiment the spacer medium may include substantially solid material that fixedly accommodates the lenses and/or other elements from at least predetermined connection points such as apertures so that subsequent adjustments therebetween can be omitted upon positioning the sub-camera relative to the sensor etc. The substrate and/or carrier material of the lenses may be similar to the surrounding medium or it may comprise different material. The medium may exhibit optically predetermined properties; it may be optically substantially transparent, for example.

In the case of lenslet arrays or multiple adjacent lenses in general, the lenses may be formed on the same substrate by depositing lens material thereon for subsequent shaping and/or by forming the lenses to the substrate material itself.

In one embodiment, a lens or a lenslet array may be formed to the target material by a selected reflow technique. In one, merely exemplary, reflow method the material, e.g. optically transparent polymer sheet, is heated over a glass transition temperature such that the surface tension causes the desired lens form; in this case controlling the lens shape is more demanding. Alternatively, a mold or a master replication tool may be applied to the target material such that the desired lens form is induced thereto. E.g. so-called hot embossing is one feasible technique. Processability of the material may be based on various properties thereof, and the material may be thermoformable, thermocurable, thermosetting (e.g. resins such as epoxy that may be thermally curable, chemically curable, or radiation, e.g. UV, curable), thermoplastic, etc. depending on the selected overall manufacturing scenario. For example, when using thermoplastic or other thermosensitive material for the lenses or other elements on a chip that shall be subsequently reflow soldered, as a camera module, to the underlying circuit board, care shall be taken in material selections such that the element does not degrade or deform, for example, during the reflow (soldering) heating stage. Both organic (e.g. polymers, various resins) and inorganic (glass, (fused) silica, ceramics) materials may be contemplated. PMMA, PET (Polyethylene terephthalate), PEN (polyethylene naphthalate), PC (polycarbonate), and COC (cyclo olefin copolymer) are given as further more specific examples.

In one embodiment, the optics of each sub-camera is selected such that the F:number remains the same between two or more, e.g. all, sub-cameras. This facilitates imaging each optical zoom step with equal brightness or e.g. one exposure. In the embodiment of FIG. 2a, the F/# could be about 3 in each lens assembly, for example.

Depending on the embodiment, the lens assembly of each sub-camera may be selected so as to implement a predetermined function, e.g. a macro(zoom) functionality, a wide angle functionality, or a telephoto functionality. The same camera arrangement may include one or more of such functionalities, again depending on the embodiment. Considering implementing a macro lens assembly in the embodiment of FIG. 2a, it might also have two lens layers, two lenses per each layer, and a field of about 1 g mm×14 mm with about 20 mm focus, for example.

The lens shapes may be function-specific and/or restricted by other requirements (dimensional design guidelines/limitations, material formability design guidelines/limitations, thermal resistance design guidelines/limitations, durability and stiffness design guidelines/limitations, etc.). The shape may include circular, triangular, pentagonal, hexagonal, star-shaped, ellipsoidal, (plano/bi)concave, (plano/bi)convex, cross-sectional, or other form(s), for example.

FIG. 2b illustrates one embodiment of the configuration and positioning of the sub-cameras in the camera arrangement of the present invention. In the case of rectangular, e.g. square, sensor area(s), it may be preferable to organize the sub-cameras in matrix form comprising a first predetermined number of lens assemblies in each row and a second predetermined number of lens assemblies in each column, wherein the first and second numbers may differ or be equal. The numbers may be positive integers starting from 1, e.g. 2×2 matrix is applicable for four zoom steps and sub-cameras/lens assemblies. Accordingly, small differences in the position of optical axes of the lens assemblies may be minimized such that upon changing the optical zoom factor from one to another, the visual artifact in the image arising from the difference remains at least small, if visible. In other words, the sub-cameras substantially shoot in the same direction. The size of the resulting three-dimensional entity, e.g. cube, cuboid, or other hexahedron, may be minimized. E.g. the measures X, Y, and Z as visualized may be about 4 mm each in the embodiment of FIG. 2a provided that 2 mm diameter sub-cameras are organized in 2×2 matrix form.

FIG. 3 illustrates one embodiment of a mixed optical and digital zoom function in the context of the present invention. For illustrative purposes, the depicted camera arrangement resembles the one of FIG. 2a, but a skilled person will appreciate the fact the basic principle is applicable to various other configurations as well. As each sub-camera and lens assembly thereof basically provides one optical zoom step Ax, Bx, Cx, or Dx, the intermediate zoom steps may be provided by digitally zooming 302, 304, 306, 308 from the nearest previous optical zoom-step image produced by the associated sub-camera. The intermediate digital zoom feature may be provided as a predetermined number of zoom steps. After the last digital zoom step, the next optical level (e.g. Bx after Ax) may be applied, if any, after which digital zooming once again takes place prior to the subsequent optical level. The device incorporating the camera arrangement may be configured so as to enable switching between optical only or optical/digital zoom modes. Further, separate control element such as button may be provided for digital zoom such that optical and digital zoom steps may be progressed via different control element(s) to facilitate skipping the undesired ones even if mixed optical/digital zoom feature is active. For example, if there are four optical zoom steps of about 1×, 1.6×, 2.3×, and 3×, the digital steps may cover ranges of about 1.1-1.5×, 1.7-2.2×, 2.4-2.9×, 3.1-3.6×, respectively in predetermined fixed, adaptive (e.g. depending (increasing/decreasing) on the zoom level), or user-defined increments. The increment may be 0.1×, for example.

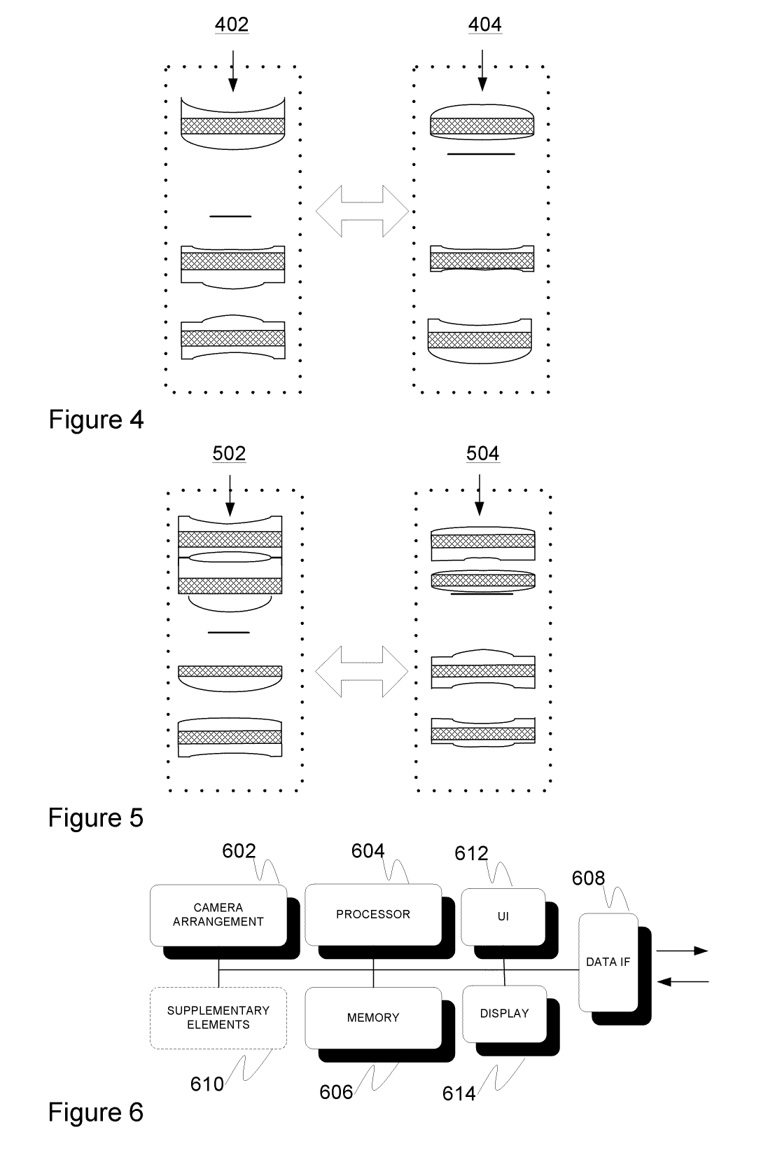

FIG. 4 illustrates a further embodiment of the present invention with additional lens layers per sub-camera. In this example, a triplet design, i.e. three lens layers per lens assembly/sub-camera, is utilized. Higher resolution, e.g. a resolution of one or more megapixels, may require more lenses to be added to the associated lens assembly, and option 402 illustrates one, merely exemplary, sketch of a wide angle sub-camera with three layers whereas option 404 illustrates one sketch of a tele such as 3× optical zoom—producing sub-camera configuration. The arrow illustrates potential switching between two possible ends of an optical zoom chain or at least sub-range provided by the camera arrangement in accordance with the present invention.

FIG. 5 illustrates still another embodiment of the present invention with further lens layers per sub-camera. In this example, a quartet design, i.e. four lens layers per lens assembly/sub-camera, is utilized. Higher resolutions may require more lenses to be added to the associated lens assembly and option 502 illustrates one, merely exemplary, sketch of a wide angle sub-camera with four layers whereas option 504 illustrates one sketch of a tele such as 4× sub-camera configuration. The arrow illustrates switching between two potential ends of an optical zoom chain or at least sub-range provided by the camera arrangement in accordance with the present invention.

FIG. 6 is a block diagram of an imaging apparatus at least functionally encompassing the camera arrangement of the present invention. The illustrated connection lines between visualized elements are merely exemplary. The apparatus may be a dedicated digital camera, a mobile terminal, a PDA, or another type of computing device supplied with the camera functionality. The camera arrangement is marked with reference numeral 602. The apparatus comprises a processing means 604 such as one or more microprocessors, microcontrollers, digital signal processors (DSPs), programmable logics, or a combination thereof for controlling the execution of tasks performed by the apparatus. The apparatus further comprises a memory means 606 such as one or more memory chips and/or cards for storing e.g. control software and/or image data. The cards may be removable and provide transfer medium between the apparatus and other devices capable of reading those. At least part of the control software may be provided on a non-volatile memory chip such as ROM memory. Yet, the apparatus optionally incorporates a data transfer means 608 such as a wireless transceiver, receiver, or transmitter, and/or a data transfer interface for wired communications, such as an USB (Universal Serial Bus) port or a Firewire-compliant (IEEE 1394) interface. Data transfer means 608 may be applied for control or image data transfer purposes. Optionally the apparatus also includes supplementary elements 610 for facilitating imaging tasks such as a flashlight, a light meter, a vibration damper, etc. A UI (user interface) 612 is a typical element in imaging apparatuses for receiving device control information from the user for e.g. zoom step selection, image acquisition initiation, image deletion, etc. The UI 612 may include keys, buttons, knobs, voice control interface, sliders, rocker switches, etc. A display 614, e.g. an LCD (liquid crystal display) screen, is still another rather useful feature for visualizing settings or imaging data, for example. The display 614 may be also used as a digital viewfinder. The display 614 may even be a touch display for acquiring control input from the user via touch pressure sensing, touch location optical sensing, or other feasible sensing arrangement. It is self-evident that further functionalities may be added to the apparatus and the aforesaid functionalities may be modified depending on the embodiment.

The scope of the invention is determined by the attached claims together with the equivalents thereof. The skilled persons will again appreciate the fact that the explicitly disclosed embodiments were constructed for illustrative purposes only, and the scope will cover further embodiments, embodiment combinations and equivalents that better suit each particular use case of the invention.

1. A zoom camera arrangement for an imaging apparatus, comprising
two or more sub-camera entities for funneling incoming light towards one or more associated digital image sensor chips,
one or more digital image sensor chips for converting light into electric signal, each chip comprising a sensor area for capturing light funneled by at least one associated sub-camera entity of said two or more sub-camera entities,
wherein each of said sub-camera entities comprises a lens assembly incorporating a number of lenses disposed as one or more lens layers of the lens assembly, said number of lenses of said lens assembly being fixedly positioned relative to the at least one associated digital image sensor chip of said one or more digital image sensor chips, wherein the lens assemblies of said two or more sub-camera entities are selected so as to provide two or more different zoom steps, respectively, for enabling the imaging apparatus to provide a particular zoom step of a multi-step optical zoom functionality via the selection of the corresponding sub-camera entity.

2. The zoom camera arrangement of claim 1, wherein lens locations within each sub-camera entity are similar.

3. The zoom camera arrangement of claim 1, wherein said two or more sub-camera entities comprise solely non-movable optical elements in said lens assemblies.

4. The zoom camera arrangement of claim 1, wherein at least one sub-camera entity is configured for telephoto imaging and comprises a telephoto lens, or for wide angle imaging and comprises a reversed telephoto lens.

5. The zoom camera arrangement of claim 1, wherein at least one sub-camera entity is configured for macro (zoom) imaging.

6. The zoom camera arrangement of claim 1, wherein said two or more sub-cameras entities are arranged in matrix form.

7. The zoom camera arrangement of claim 1, wherein F:number of each of said one or more sub-camera entities is substantially equal.

8. The zoom camera arrangement of claim 1, wherein at least one of said one or more digital image sensor chips comprises a sensor area utilized by a plurality of said two or more sub-camera entities.

9. The zoom camera arrangement of claim 1, wherein each of said lens assemblies of said two or more sub-camera entities is unique relative to the other assemblies.

10. The zoom camera arrangement of claim 1, wherein at least two of said two or more sub-camera entities have a different aperture size or position.

11. The zoom camera arrangement of claim 1, wherein at least some of the lenses of adjacent sub-camera entities residing on a same lens layer are formed by a lenslet array.

12. The zoom camera arrangement of claim 1, wherein each sub-camera entity comprises three or four lens layers in the lens assembly thereof.

13. A digital imaging apparatus, such as a digital camera or camera-equipped mobile terminal, personal digital assistant, or a computer, incorporating the arrangement of claim 1.

14. The digital imaging apparatus of claim 13, configured to provide a digital zoom feature between two optical zoom steps and/or extending the zoom factor of the highest optical zoom step provided.

15. (canceled)

16. The zoom camera arrangement of claim 2, wherein said two or more sub-camera entities comprise solely non-movable optical elements in said lens assemblies.

17. The zoom camera arrangement of claim 2, wherein at least one sub-camera entity is configured for telephoto imaging and comprises a telephoto lens, or for wide angle imaging and comprises a reversed telephoto lens.

18. The zoom camera arrangement of claim 2, wherein at least one sub-camera entity is configured for macro (zoom) imaging.

19. The zoom camera arrangement of claim 2, wherein said two or more sub-cameras entities are arranged in matrix form.
